(19) United States
(12) Patent Application Publication
(10) Pub. No.: US 2012/0075617 A1
(43) Pub. Date: Mar. 29, 2012

(54) LASER NAVIGATION MODULE

(75) Inventor: Ki Hoon JANG, Gyunggi-do (KR)

(73) Assignee: SAMSUNG ELECTRO-MECHANICS CO., LTD., Gyunggi-do (KR)

(21) Appl. No.: 12/964,974

(22) Filed: Dec. 10, 2010

(30) Foreign Application Priority Data
Sep. 27, 2010 (KR) 1020100093354

(51) Int. Cl. G01B 11/14; H01J 40/14

(52) U.S. Cl. 356/51; 250/221; 356/614

(57) ABSTRACT

Disclosed herein is a laser navigation module. A light source emits a laser beam. A housing includes an IR window and a transparent or semitransparent part. The IR window transmits or reflects the laser beam emitted from the light source, and also interrupts transmission of external visible rays. The transparent or semitransparent part allows light emitted in the housing to be transmitted out of the housing. An illuminator is installed in the housing. A light diffusion unit transmits the light emitted from the illuminator to the housing. A re-reflective layer is formed on the upper surface of the light diffusion unit.

### CROSS REFERENCE TO RELATED APPLICATION

This application claims the benefit of Korean Patent Application No. 10-2010-0093354, filed Sep. 27, 2010, entitled “Laser Navigation Module”, which is hereby incorporated by reference in its entirety into this application.

### BACKGROUND OF THE INVENTION

1. Technical Field

The present invention relates to a laser navigation module.

2. Description of the Related Art

Generally, personal mobile telecommunication terminals, such as cellular phones or smartphones, include user interfaces that use keypads. The keypads include input buttons pertaining to numerals, characters and directions.

Recently, the commercialization of wireless internet services, such as WIBRO (wireless broadband) services, has led to the development of personal mobile telecommunication terminals which use windows operating systems supporting GUIs (graphical user interfaces).

This means that operating systems supporting GUIs are used as the user interfaces of personal mobile telecommunication terminals. Hence, there is a demand for the development of input devices which are suitable for such mobile telecommunication terminals and are devised such that users to easily and conveniently use them. To achieve this, various devices, such as touch keys, joysticks, and optical pointing devices, etc. have been developed, the touch keys being configured such that keypads are displayed on the displays of mobile telecommunication terminals and users input signals using the keypads. Laser navigation modules including windows and lids are also representative examples of these devices.

However, conventional laser navigation modules have no separate illuminators. Thus, users cannot easily use the modules in dark places.

In detail, FIG. 1 is an exploded perspective view showing a laser navigation module 100, which is an input device for mobile telecommunication terminals, according to a conventional technique. As shown in FIG. 1, the laser navigation module 100 includes an IR window 110, a housing 120, a lid 130, a control IC chip 140, a PCB (printed circuit board) 150 and a dome switch 160.

A laser beam emitted from a light source is transmitted through the IR window 110 and then reflected off the body of a user, for example, his/her hand. The IR window 110 is installed in the housing 120.

The lid 130 is disposed below the IR window 110. The lid 130 functions as a screen which blocks transmission of external stray light. The lid 130 has a stepped portion 131, a circular hole 132 and a rectangular passing hole 133. The lid 130 can be more closely coupled to the housing 110 by the stepped portion 131. A laser beam emitted from the light source is transmitted through the circular hole 132. The laser beam is reflected or refracted by the body of the user that is in contact with the IR window. The reflected or refracted laser beam passes through the rectangular passing hole 133.

The control IC chip 140 includes a VCSEL (vertical-cavity surface-emitting laser) 141 which is the light source. The control IC chip 140 calculates the displacement value of a laser beam which is reflected or refracted by the IR window 110. The control IC chip 140 is mounted to the PCB 150. The dome switch 160 is coupled to the lower surface of the PCB 150. The dome switch 160 senses pressure applied to the IR window 110 by the user and transmits the signal selected by the user to a control unit (not shown) which is disposed below the dome switch 160.

However, this conventional laser navigation module has no separate illuminator and so is inconvenient to use in dark places. Although an illuminator may be provided separately outside of the laser navigation module, the separate illuminator cannot be easily installed in the laser navigation module, because the laser navigation module is too small. Furthermore, even if the illuminator could be installed in the laser navigation module, it is very difficult to manufacture a laser navigation module that uniformly transmits light emitted from the illuminator to the outside of the laser navigation module.

### SUMMARY OF THE INVENTION

The present invention has been made in an effort to provide a laser navigation module which includes an illuminator installed in a housing, and a light diffusion unit which diffuses light emitted from the illuminator. A re-reflective layer is formed on an upper surface of the light diffusion unit and another re-reflective layer is selectively formed under a lower surface of the light diffusion unit, so that light can be uniformly emitted out of the laser navigation module by the re-reflection of light, thus facilitating use of the laser navigation module even in dark places.

In a laser navigation module according to an embodiment of the present invention, a light source emits a laser beam. A housing includes an IR window and a transparent or semitransparent part. The IR window transmits or reflects the laser beam emitted from the light source. The IR window interrupts transmission of external visible rays. The transparent or semitransparent part allows light emitted from in the housing to be transmitted out of the housing. An illuminator is installed in the housing. A light diffusion unit transmits the light emitted from the illuminator to the housing. A re-reflective layer is formed on an upper surface of the light diffusion unit.

The light diffusion unit may have a through hole through which the laser beams emitted from the light source pass. A protrusion may be disposed at a position corresponding to the illuminator. The protrusion may change a direction of the light emitted from the illuminator. The re-reflective layer may have an opening at a position corresponding to the through hole.

The re-reflective layer may be formed on a portion of the upper surface of the light diffusion unit other than a perimeter of the upper surface of the light diffusion unit. The re-reflective layer may comprise a layer coated with silver (Ag).

The light diffusion unit may have a through hole through which the laser beams emitted from the light source pass. A protrusion may be disposed at a position corresponding to the illuminator. The protrusion may change a direction of the light emitted from the illuminator. The re-reflective layer may be formed on a portion of the upper surface of the light diffusion unit other than portions corresponding to the through hole and the protrusion. A lower re-reflective layer may be further formed on the light diffusion unit at a position facing the illuminator.

The lower re-reflective layer may have an opening corresponding to the through hole and the protrusion of the light diffusion unit.

The light diffusion unit may comprise two portions including a first portion having the protrusion, and a second portion other than the first portion having the protrusion. The re-reflective layer may be formed on the second portion. The lower re-reflective layer may comprise a mirror tape coated with silver (Ag).

The laser navigation module may further include a lid disposed below the IR window. The lid may block transmission of stray external light. A circular hole and a rectangular passing hole may be formed in the lid. The control IC chip may have the light source. The control IC chip may calculate a displacement value of the laser beam that is reflected or refracted by the IR window and returned. The control IC chip may be mounted to a printed circuit board. A dome switch may be provided below the printed circuit board.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view showing a laser navigation module according to a conventional technique;

FIG. 2 is a sectional view of a laser navigation module, according to the present invention;

FIG. 3 is a perspective view of a light diffusion unit of a laser navigation module according to a first embodiment of the present invention;

FIG. 4 is an exploded perspective view showing a light diffusion unit and mirror tape of a laser navigation module according to a second embodiment of the present invention; and

FIG. 5 is an exploded perspective view showing a light diffusion unit and mirror tape of a laser navigation module according to a third embodiment of the present invention.

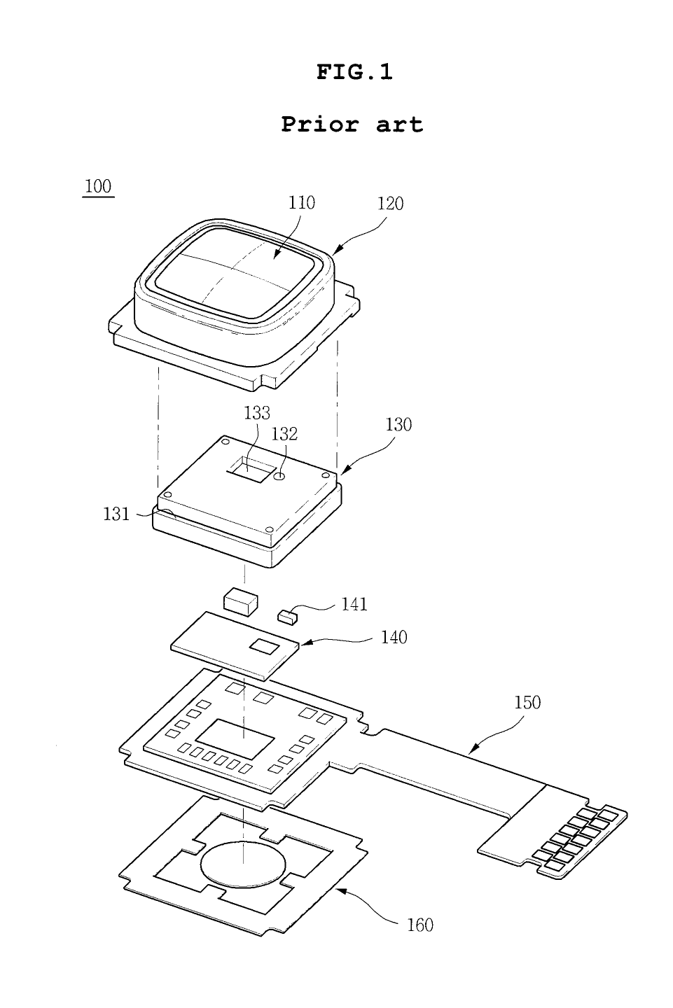

### DESCRIPTION OF THE PREFERRED EMBODIMENTS

Reference now should be made to the drawings, in which the same reference numerals are used throughout the different drawings to designate the same or similar components. In the following description, when it is determined that the detailed description of the conventional function and conventional structure would confuse the gist of the present invention, such a description may be omitted. Furthermore, it will be understood that, although the terms “first”, “second” etc. may be used herein to describe various elements, components, regions, layers and/or sections, these elements, components, regions, layers and/or sections should not be limited by these terms. These terms are only used to distinguish one element, component, region, layer or section from another element, component, region, layer or section.

Hereinafter, embodiments of the present invention will be described in detail with reference to the attached drawings.

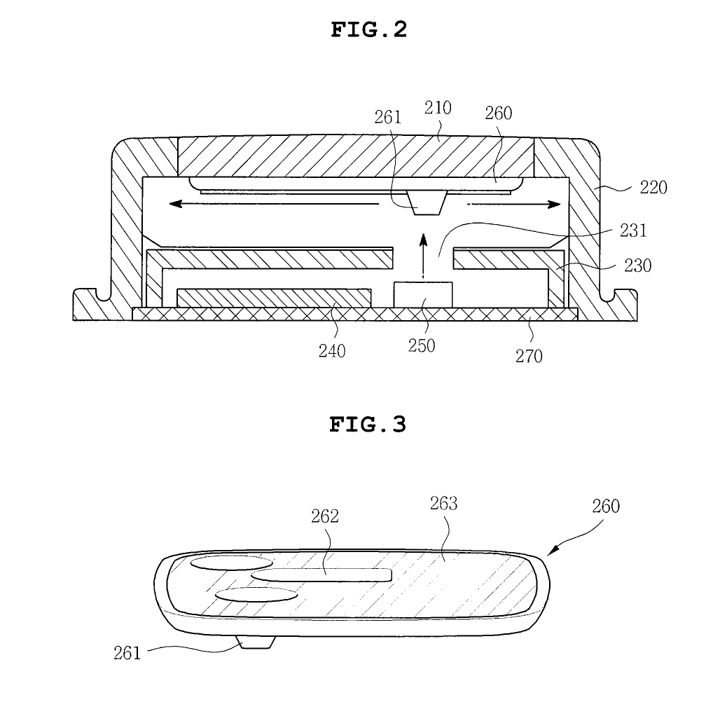

FIG. 2 is a sectional view of a laser navigation module, according to an embodiment of the present invention. AS shown in FIG. 2, the laser navigation module 200 includes an IR window 210, a housing 220, a VCSEL (vertical-cavity surface-emitting laser, not shown), a lid 230, a control IC chip 240, an illuminator 250, a light diffusion unit 260, a PCB (printed circuit board) 270 and a dome switch (not shown).

According to a stacking sequence, the PCB 270 is placed on the dome switch (not shown), and the control IC chip 240, the VCSEL (not shown) and the illuminator 250 are mounted to an upper surface of the PCB 270. The lid 230 is coupled to the PCB 270 and disposed above the VCSEL and the illuminator. Furthermore, the light diffusion unit 260 is provided above the lid 230. The housing 220 provided with the IR window 210 is coupled to an upper surface of the light diffusion unit 260.

In detail, the lid 230 is a screen which blocks the transmission of external stray light. A circular hole (not shown) and a rectangular passing hole are formed in the lid 230 so that a laser beam emitted from the VCSEL (the light source) passes through the circular hole and the rectangular passing hole. A hole 231 is formed through the lid 230 so that light emitted from the illuminator 250 passes through the hole 231.

The control IC chip 240 includes the VCSEL and calculates a displacement value of a laser beam which is reflected or refracted by the IR window 110. The VCSEL is the light source which emits the laser beam which is transmitted through or reflected by the IR window 210. The IR window 210 interrupts transmission of external visible rays.

The illuminator 250 emits light out of the housing 220.

The light diffusion unit 260 includes a protrusion 261 which changes a path of light emitted from the illuminator 250 and diffuses the light, and a through hole (262 of FIG. 3) through which a laser beam emitted from the VCSEL passes.

In an embodiment, an LED is used as the illuminator 250.

The housing 220 of the laser navigation module according to the present invention is made of transparent or semitransparent material such that light emitted from the illuminator 250 is transmitted out of the housing 220.

FIG. 3 is a perspective view of a light diffusion unit 260 of the laser navigation module according to a first embodiment of the present invention. As shown in FIG. 3, the light diffusion unit 260 is disposed at a position corresponding to the illuminator 250. The light diffusion unit 260 includes a protrusion 261 which changes the path of light emitted from the illuminator, and a through hole 262 through which a laser beam emitted from the VCSEL (not shown) that is the light source passes. Because the protrusion 261 is configured to correspond to the illuminator, if the illuminator comprises a plurality of illuminators, the protrusion 261 also comprises a plurality of protrusions 261 each of which corresponds to a respective illuminator.

Furthermore, a re-reflective layer 263 is formed on an upper surface of the light diffusion unit 260. In this embodiment, the re-reflective layer 263 is formed on a portion of the upper surface of the light diffusion unit 260 other than the perimeter of the upper surface. Thereby, light emitted from the illuminator is transmitted to the housing through the perimeter of the light diffusion unit 260. In addition, the re-reflective layer 263 has an opening at a position corresponding to the through hole 262 of the light diffusion unit 260. In the embodiment, the re-reflective layer 263 is coated with silver (Ag). Moreover, to emit light from the illuminator out of the housing through the light diffusion unit 260 with uniform brightness, it is desirable that the re-reflective layer 263 be designed in various patterns and then the optimal pattern be selected by testing the brightness of light diffused out of the housing.

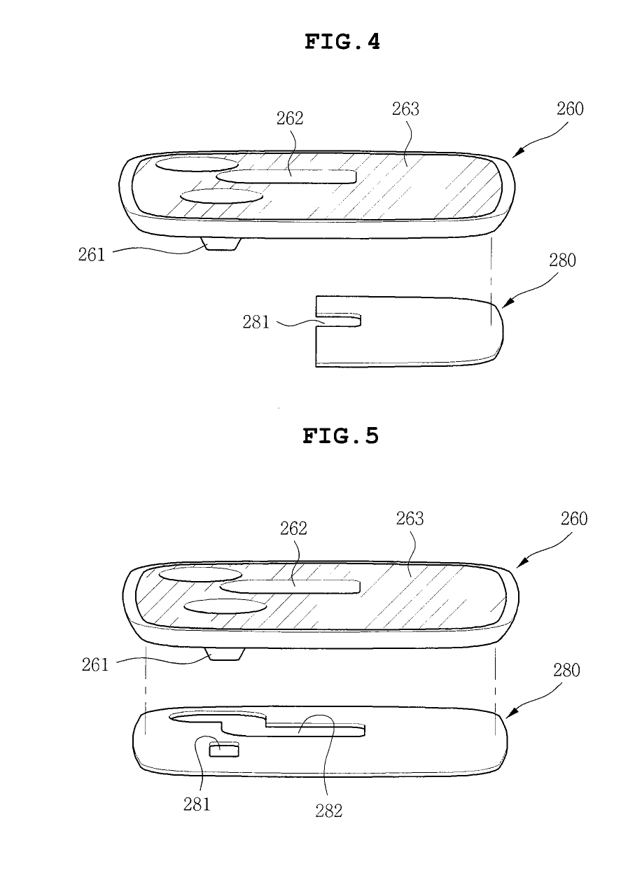

FIG. 4 is an exploded perspective view showing a light diffusion unit 260 and mirror tape 280 of a laser navigation module according to a second embodiment of the present invention. As shown in FIG. 4, the laser navigation module according to the second embodiment further includes a lower re-reflective layer which is formed under a lower surface of the light diffusion unit 260 facing the illuminator. The lower re-reflective layer is realized by mirror tape 280 coated with silver (Ag).

The mirror tape 280 re-reflects light reflected off of an upper surface of the light diffusion unit 260.

Furthermore, taking into account the fact that a lot of light is reflected off of a region adjacent to the protrusion 261 of the light diffusion unit 260, the mirror tape 280 should be formed on a portion of the light diffusion unit 260 other than the region adjacent to the protrusion 261. Thereby, uniform diffusion of light and uniform brightness can be ensured. In the embodiment of FIG. 4, the light diffusion unit 260 has the region including the protrusion 261, and the other region which does not include the protrusion 261. The mirror tape 280 is formed on the region that does not include the protrusion. An opening 281 is formed in the mirror tape 280 at a position corresponding to the through hole 262.

Moreover, the re-reflective layer can be realized by various methods, for example, it may be realized by the mirror tape or, alternatively, it may be realized by applying coating material onto the light diffusion unit 260.

FIG. 5 is an exploded perspective view showing a light diffusion unit 260 and mirror tape 280 of a laser navigation module according to a third embodiment of the present invention. As shown in FIG. 5, a re-reflective layer is partially formed at a side of the light diffusion unit 260 that faces the illuminator. The re-reflective layer may comprise a mirror tape 280 coated with silver (Ag). In this case, the re-reflective layer can be formed by attaching the mirror tape 280 to the corresponding surface of the light diffusion unit 260. The mirror tape 280 has an opening 281 corresponding to the protrusion 261, and another opening 282 corresponding to the through hole 261. FIG. 5 illustrates the mirror tape 280 having the shape corresponding to the light diffusion unit 260 provided with two protrusions 261. In detail, to more effectively couple the mirror tape 280 to the light diffusion unit 260, the mirror tape 280 has a first opening 281 corresponding to one protrusion 261, and a second opening 282 corresponding to the other protrusion and the through hole 262. Furthermore, the re-reflective layer can be realized by various other methods, for example, it may be realized by applying coating material to the light diffusion unit 260.

As described above, in a laser navigation module according to the present invention, an illuminator is installed in a housing. A light diffusion unit diffuses light emitted from the illuminator. A re-reflective layer is formed on an upper surface of the light diffusion unit and a lower re-reflective layer is formed under a lower surface of the light diffusion unit. Hence, light can be uniformly emitted out of the laser navigation module by the re-reflection of light, thus facilitating the use of the laser navigation module even in dark places.

Although the embodiment of the present invention has been disclosed for illustrative purposes, it will be appreciated that the laser navigation module according to the invention is not limited thereto, and those skilled in the art will appreciate that various modifications, additions and substitutions are possible, without departing from the scope and spirit of the invention.

What is claimed is:

1. A laser navigation module, comprising:
a light source emitting a laser beam;
a housing, comprising: an IR window transmitting or reflecting the laser beam emitted from the light source, the IR window interrupting transmission of external visible rays; and a transparent or semitransparent part allowing light emitted from in the housing to be transmitted out of the housing;
an illuminator installed in the housing; and
a light diffusion unit transmitting the light emitted from the illuminator to the housing, with a re-reflective layer formed on an upper surface of the light diffusion unit.

2. The laser navigation module as set forth in claim 1, wherein the light diffusion unit comprises:
a through hole through which the laser beams emitted from the light source pass; and
a protrusion disposed at a position corresponding to the illuminator, the protrusion changing a direction of the light emitted from the illuminator, and
the re-reflective layer has an opening at a position corresponding to the through hole.

3. The laser navigation module as set forth in claim 2, wherein the re-reflective layer is formed on a portion of the upper surface of the light diffusion unit other than a perimeter of the upper surface of the light diffusion unit.

4. The laser navigation module as set forth in claim 1, wherein the re-reflective layer comprises a layer coated with silver (Ag).

5. The laser navigation module as set forth in claim 1, wherein the light diffusion unit comprises:
a through hole through which the laser beams emitted from the light source pass; and
a protrusion disposed at a position corresponding to the illuminator, the protrusion changing a direction of the light emitted from the illuminator, and
the re-reflective layer is formed on a portion of the upper surface of the light diffusion unit other than portions corresponding to the through hole and the protrusion, and a lower re-reflective layer is further formed on the light diffusion unit at a position facing the illuminator.

6. The laser navigation module as set forth in claim 5, wherein the lower re-reflective layer has an opening corresponding to the through hole and the protrusion of the light diffusion unit.

7. The laser navigation module as set forth in claim 5, wherein the light diffusion unit comprises two portions including a first portion having the protrusion, and a second portion other than the first portion having the protrusion, and the re-reflective layer is formed on the second portion.

8. The laser navigation module as set forth in claim 5, wherein the lower re-reflective layer comprises a mirror tape coated with silver (Ag).

9. The laser navigation module as set forth in claim 1, further comprising:
a lid disposed below the IR window, the lid blocking transmission of stray external light, with a circular hole and a rectangular passing hole formed in the lid;
a control IC chip having the light source, the control IC chip calculating a displacement value of the laser beam that is reflected or refracted by the IR window and returned;
a printed circuit board to which the control IC chip is mounted; and
a dome switch provided below the printed circuit board.
